(19) United States
(12) Patent Application Publication
(10) Pub. No.: US 2026/0034908 A1
(43) Pub. Date: Feb. 5, 2026

(54) DOCKING STATION SYSTEMS AND METHODS FOR POOL CLEANERS

(71) Applicant: ZODIAC POOL CARE EUROPE, Belberaud (FR)

(72) Inventors: Arnaud Lancry, Le Vernet D'Ariege (FR); Thomas Rosin, Auterive (FR); Simon Duffaut, Castelginest (FR); Louis Favié, Colomiers (FR); Rémi Deloche, Toulouse (FR)

(73) Assignee: ZODIAC POOL CARE EUROPE, Belberaud (FR)

(21) Appl. No.: 19/285,126

(22) Filed: Jul. 30, 2025

Related U.S. Application Data
(60) Provisional application No. 63/677,810, filed on Jul. 31, 2024.

(51) Int. Cl. B60L 53/51; B60L 53/50; B60L 53/53; E04H 4/16

(52) U.S. Cl. CPC B60L 53/51; B60L 53/50; B60L 53/53; E04H 4/1654; B60L 2200/40

(57) ABSTRACT

A docking station for a self-propelled pool cleaner may be supported at one or more locations within a swimming pool or spa, such as but not limited to a skimmer of the swimming pool or spa, a port for a circulation system of the pool or spa such as an inlet or an outlet, a pool light fitting of the pool or spa, and/or on a floor of the pool or spa. The docking stations may utilize existing features of the swimming pool or spa without requiring additional devices or systems for installing the docking station.

### REFERENCE TO RELATED APPLICATION

This application claims the benefit of and priority to U.S. Provisional Patent Application No. 63/677,810, filed on Jul. 31, 2024, and entitled DOCKING STATION SYSTEMS AND METHODS FOR POOL CLEANERS, the content of which is hereby incorporated by reference in its entirety.

### FIELD OF THE INVENTION

The invention relates to swimming pool cleaners and other battery-driven robots or cleaners, and more particularly, to docking stations for such battery-driven cleaners.

### BACKGROUND OF THE INVENTION

Numerous cleaning devices capable of autonomous movement within swimming pools and spas currently exist. The most common of these devices are pool cleaners, which often are either hydraulic or robotic in type. Hydraulic cleaners vary water flow for movement, while robotic cleaners typically employ electric motors to cause motion. Hydraulic pool cleaners, furthermore, subdivide into “pressure-side” and “suction-side” cleaners, with pressure-side cleaners being fluidly connected to outputs of pumps of pool water circulation systems and suction-side cleaners being fluidly connected to inputs of such pumps.

Battery-driven pool cleaners are becoming increasingly popular. Depending on the duration of the cleaning cycle, battery-driven pool cleaners may require charging at various time intervals or frequencies utilizing charging stations. Charging stations typically may be of two types—a “pool cleaner garage,” or docking stations. Pool cleaner garages are embedded inside of the pool wall, stairs, or floor, and usually must be planned during pool construction. Most docking stations are external or out of water of the pool or spa, although some docking stations are supported along an edge of the pool or spa. Existing approaches for docking a pool cleaner are thus somewhat limited and/or complex to implement. Moreover, providing power to such docking stations is challenging, and cabling must be run from a shore power source, through a transformer, and across the pool deck to the docking station. Such cabling is unsightly and may be difficult to make safe and aesthetically pleasing. Moreover, while docking stations may provide flexibility for location, anchoring such docking stations with sufficient rigidity is challenging, as pool owners are averse to drilling into the pool deck, coping, or wall.

### SUMMARY

Embodiments covered by this patent are defined by the claims below, not this summary. This summary is a high-level overview of various embodiments and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

According to certain embodiments, a docking station for a pool cleaner includes a dock attachable to at least one of a skimmer of a pool or spa, a port of a circulation system of the pool or spa, or a pool light fitting of the pool or spa.

According to various embodiments, a dock for a pool cleaner is attachable to the skimmer.

According to some embodiments, a dock for a pool cleaner is attachable to a circulation port.

According to certain embodiments, a dock for a pool cleaner is attachable to a pool light fitting.

According to various embodiments, a docking station includes a dock that is positionable on a floor or generally horizontal submerged surface of a pool or spa, and the dock includes a solar panel.

According to some embodiments, an underwater docking station for a pool cleaner may be configured to generate electrical energy based on a flow of water.

Various implementations described herein can include additional systems, methods, features, and advantages, which cannot necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The specification makes reference to the following appended figures, in which use of like reference numerals in different figures is intended to illustrate like or analogous components.

FIG. 1 illustrates a pool system with a docking system according to embodiments.

FIG. 2 is another view of the pool system of FIG. 1 according to embodiments.

FIG. 3 illustrates a pool system with a docking system according to embodiments.

FIG. 4 illustrates a pool system with a docking system according to embodiments.

FIG. 5 is another view of the pool system of FIG. 4 according to embodiments.

FIG. 6 illustrates a pool system with a docking system according to embodiments.

FIG. 7 illustrates a pool system with a docking system according to embodiments.

### DESCRIPTION OF THE INVENTION

Described herein are docking stations and associated methods for self-propelled pool cleaners. Compared to traditional docking stations, the systems and methods described herein may provide sturdy, in-pool docking stations which are easy to install, may require fewer parts to install, and/or may be provided at a plurality of locations within a pool or spa. In certain embodiments, the systems and methods described herein provide docking stations with improved modularity, and a user may install the docking station at a location as desired. In certain embodiments, the systems and methods described herein are modular and may be utilized both within a pool and outside of a pool. As an example, if a pool is not being used during the winter, a user may remove the docking station and charge the cleaner outside of the pool.

In some embodiments, the systems and methods described herein may provide docking stations which may be supported at locations such as but not limited to a skimmer of the pool or spa, a port (e.g., suction inlet and/or outlet) for a circulation system of the pool or spa, a pool light fitting of the pool or spa, and/or on a floor of the pool or spa, combinations thereof, and/or as otherwise desired. In certain embodiments, the docking stations described herein may utilize existing features of the pool or spa (e.g., light fittings, port fittings, skimmers, etc.) without requiring additional devices or systems for installing the docking station.

Compared to traditional approaches, the docking stations described herein may have improved cable management, and/or may provide electrical cabling that extends through the existing pool features (e.g., through the skimmer, through the light fitting, etc.). As non-limiting examples, electrical cabling may be provided through a circulation port (e.g., inlet and/or outlet pipe) and/or through a pool light fitting, thereby allowing for power and/or data to be provided to the docking station without requiring cabling on a submerged pool surface, coping of the pool, and/or the pool deck, combinations thereof, and/or as otherwise desired.

Additionally, or alternatively, the systems and methods described herein may include one or more onboard power sources for charging a pool cleaner while the pool cleaner is docked with the docking station, such as but not limited to a solar panel and/or a battery. Additionally, or alternatively, the onboard power source may generate energy based on a flow of water. As a non-limiting example, the docking station may include a power generating system which generates energy for charging a pool cleaner and/or an onboard battery based on a flow of water through a circulation port of a circulation system of the pool or spa. Optionally, the onboard power supply may be removable and/or disconnected from the docking station as desired.

Optionally, the docking stations described herein include one or more human machine interfaces for receiving input from a user and/or for providing output to a user. The human machine interfaces may be provided onboard the docking station and/or may be remote from the docking station as desired. Optionally, the human machine interface may be in an application running on a remote device (e.g., a user device, cloud, etc.), and the docking stations described herein may include various communications modules or means enabling wireless communication with one or more remote devices, such as a user device, cloud, remote device, and/or as otherwise desired.

Various other benefits and advantages may be realized with the systems, devices, and methods provided herein, and the aforementioned advantages should not be considered limiting.

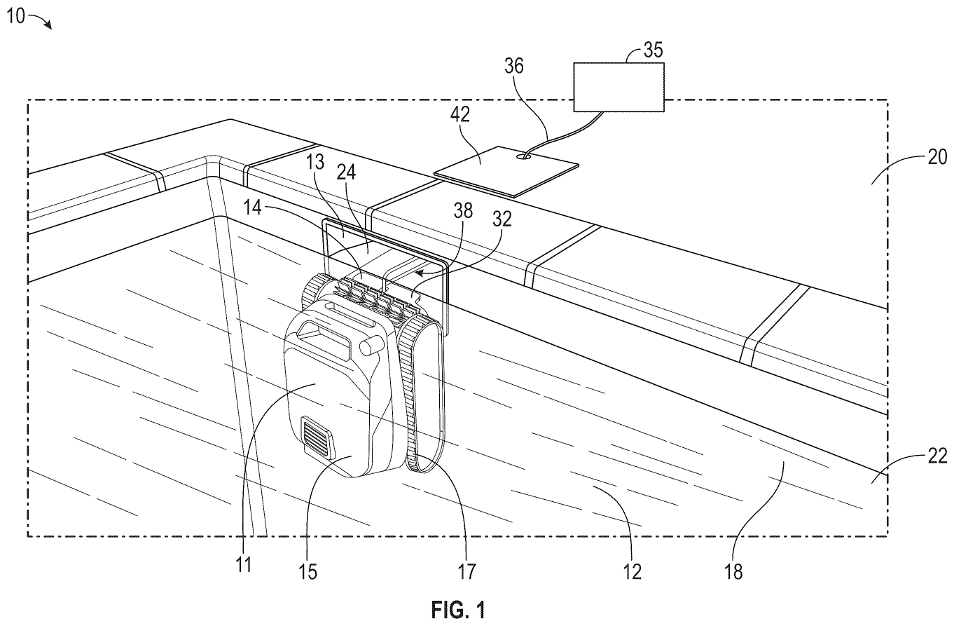

FIGS. 1-7 illustrate a pool system 10 with a pool 12 and one or more docking stations 14 for a pool cleaner 11 according to embodiments.

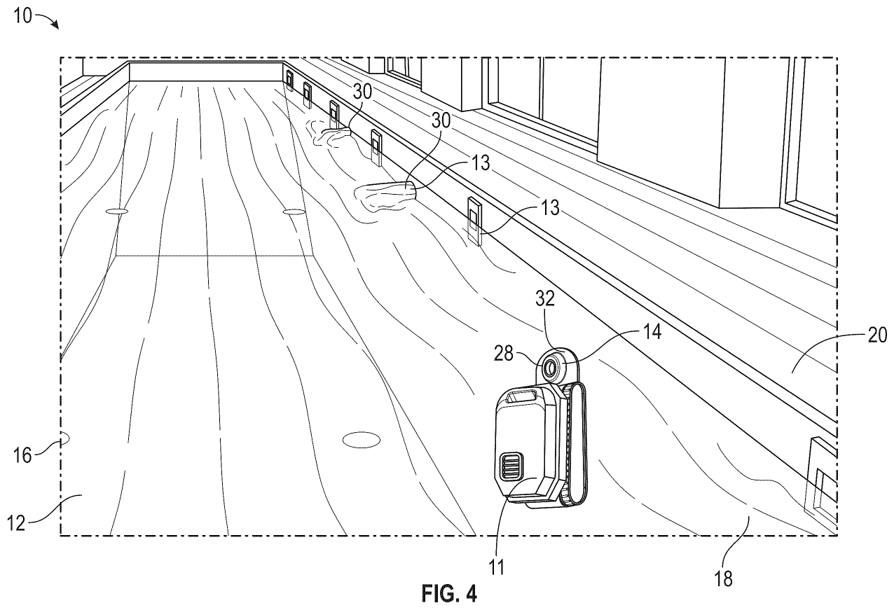

The pool 12 may have various shapes, sizes, and dimensions, as desired, and those illustrated in FIGS. 1-6 should not be considered limiting. The pool 12 generally includes a floor 16 (see FIG. 4) and one or more walls 18. Optionally, the pool 12 may include surfaces such as but not limited to stairs, a bench, a sun shelf, a beach, combinations thereof, and/or as otherwise desired. A pool deck 20 may at least partially surround the pool 12 and above a waterline 22 of the pool 12.

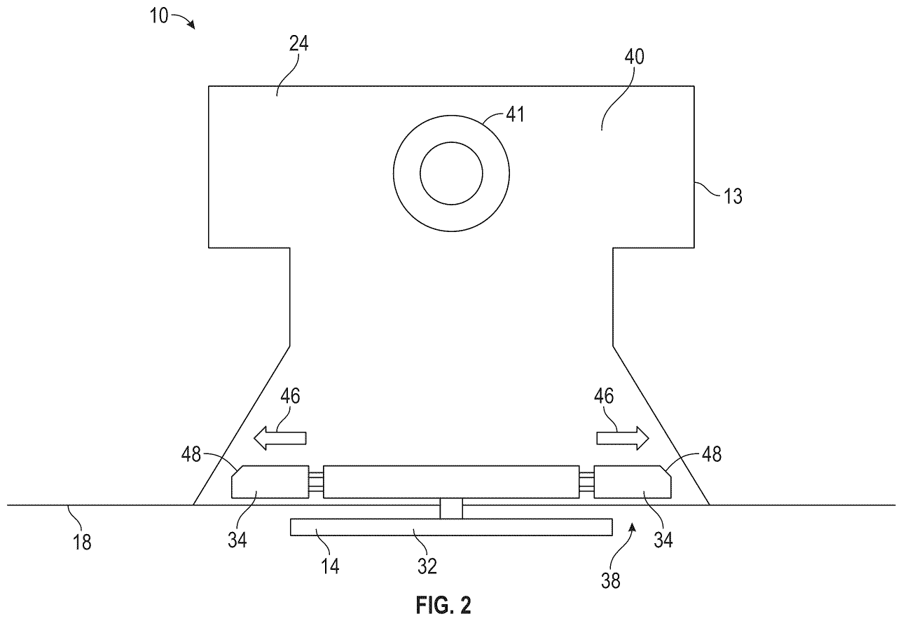

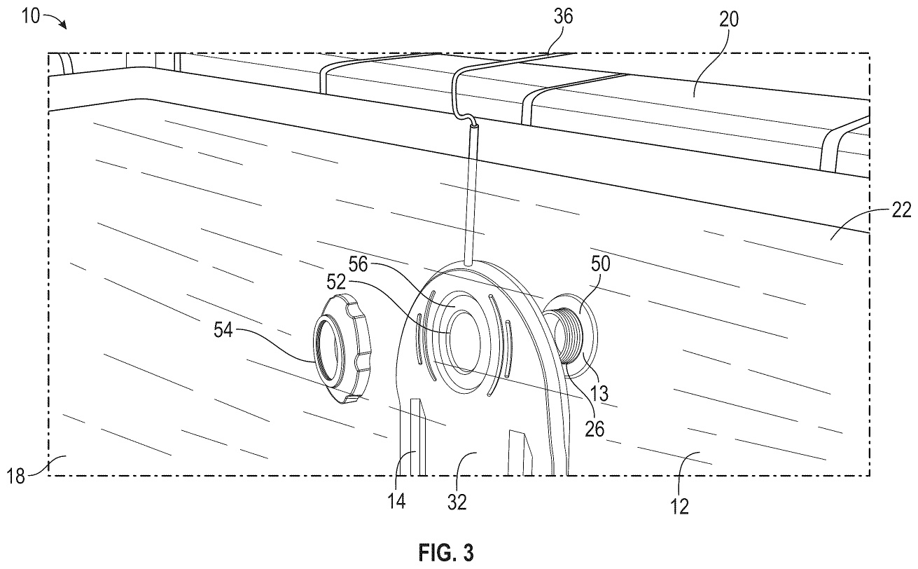

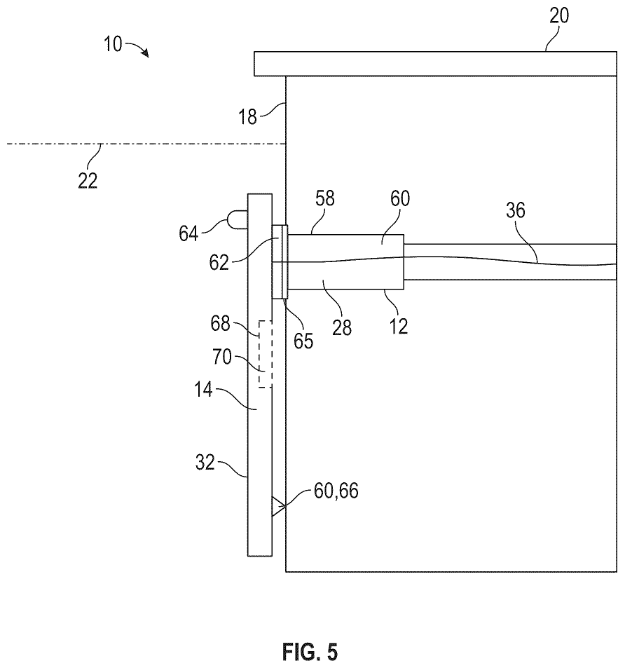

The pool 12 may include various features 13 and/or combinations of features within the pool 12. Such features 13 may be provided for various purposes, such as but not limited to illumination, water filtering, water circulation, water quality control, combinations thereof, and/or as otherwise desired. As non-limiting examples, the features 13 of the pool 12 may include one or more skimmers 24 (see, e.g., FIGS. 1 and 2), one or more circulation ports 26 for a water circulation system (see, e.g., FIG. 3), one or more pool light fittings 28 for a pool light 30 (see, e.g., FIGS. 4 and 5), combinations thereof, and/or as otherwise desired. The location, number, and type of features 13 should not be considered limiting, and in other embodiments, pool systems 10 may include other features 13 or combinations as desired.

The pool cleaner 11 may be various self-propelled pool cleaners as desired, and the pool cleaner 11 illustrated should not be considered limiting. In some embodiments, the pool cleaner 11 may be a robotic cleaner using electrical power for movement and cleaning. The pool cleaner 11 generally includes a housing 15, one or more motive elements 17 (e.g., wheels, tracks, rollers, combinations thereof, etc.), and one or more cleaning devices (including but not limited to one or more brush assemblies). A motor, pump, filter, controller, and/or various other features or combinations of features may be provided on or within the pool cleaner 11 as desired. In certain embodiments, the pool cleaner 11 includes an on-board power source, such as but not limited to one or more on-board batteries. Non-limiting examples of pool cleaners 11 may include those described in U.S. Pat. Nos. 10,316,534, 9,488,154, 8,578,538, and U.S. Patent Publication No. 2014/0303810, all of which are hereby incorporated by reference in their entireties.

The docking station 14 may allow for at least in-pool docking with the pool cleaner 11, and optionally allows for both in-pool docking and out of pool docking as desired. The docking station 14 generally includes a dock 32, which may have various constructions and/or features suitable for selectively engaging the pool cleaner 11 and/or charging the pool cleaner 11.

As a non-limiting example, the dock 32 may include one or more charging locations for charging an onboard power source of the pool cleaner 11 and/or for communicating with the pool cleaner 11. Various charging features may be utilized at the one or more charging locations, such as but not limited to a feature for contactless charging of the pool cleaner 11 (e.g., via induction).

Optionally, the dock 32 may include one or more positioning mechanisms for at least temporarily supporting the pool cleaner 11 on the dock 32 and/or orienting or positioning the pool cleaner 11 relative to the dock 32. Positioning mechanisms may include, but are not limited to, latches, hooks, magnets, electromagnets, combinations thereof, and/or other support mechanisms as desired.

In some embodiments, electrical cabling 36 (e.g., for power and/or data communication) may extend from the dock 32 and is connectable to one or more external devices. External devices may include, but are not limited to, an external power source, a human machine interface, a control box, combinations thereof, and/or other external or remote devices as desired. In other embodiments, the docking station 14 need not include electrical cabling 36, and the docking station 14 may include onboard power sources and/or have wireless communication as discussed in detail below.

In certain embodiments, and as illustrated in FIGS. 1-5, the docking station 14 may include various components, features, and/or mechanisms enabling the dock 32 to be supported on and/or attached to various features 13 of the pool 12. Examples of such components, features, and/or mechanisms are described in greater detail below but should not be considered limiting. Moreover, in some embodiments, a docking station 14 may include a plurality of features enabling attachment of the dock 32 to a plurality of types of features 13 in various combinations or sub-combinations as desired.

Referring to FIGS. 1 and 2, in some embodiments, the docking station 14 includes features or components such that the docking station 14 may be supported in and/or around the skimmer 24. In some embodiments, and as illustrated in FIG. 1, the docking station 14 may be attachable to the skimmer 24 such that the dock 32 extends along the wall 18 of the pool 12 and/or along a generally vertical surface of the pool 12.

As illustrated in FIGS. 1 and 2, the skimmer 24 generally includes an opening 38 and an interior 40, and a skimmer basket 41 may be provided within the interior 40 for collecting debris from the water. In some embodiments, a top opening 42 may allow for access to the interior 40. The particular skimmer 24 illustrated should not be considered limiting, and in other embodiments, skimmers 24 may have other shapes, constructions, and features as desired.

In embodiments where the docking station 14 is attachable to the skimmer 24, the docking station 14 may include one or more engagement devices 34 which may support the dock 32 on the skimmer 24. In certain embodiments, the one or more engagement devices 34 are connected to the dock 32 and may engage the skimmer 24 at or proximate to the opening 38. In one non-limiting example, and as illustrated in FIG. 2, the engagement devices 34 may engage walls of the interior 40 of the skimmer 24 at or proximate to the opening 38. Optionally, the engagement devices 34 include a friction member 48 and/or other device, feature, or mechanisms facilitating engagement between the skimmer 24 and the engagement devices 34.

In some cases, the engagement devices 34 are fixed relative to the dock 32. In such embodiments, the docking station 14 may be supported on the skimmer 24 by positioning the engagement features 34 until they are in engagement with the skimmer 24. In other embodiments, and as illustrated in FIG. 2, the one or more engagement devices 34 are movable or adjustable relative to the dock 32 (represented by arrows 46). In such embodiments, the adjustable engagement devices 34 may allow the docking station 14 to be attached, supported on, and/or otherwise engage skimmers 24 of various shapes, sizes, or dimensions. In some embodiments, the engagement devices 34 are slidable or linearly movable relative to the dock 32, although in other embodiments they may be capable of additional and/or alternative movement as desired, such as but not limited to pivoting, rotating, tilting, combinations thereof, etc. Optionally, linearly movable engagement devices 34 may be movable between a base configuration, in which the engagement devices 34 have a first length, and an extended configuration, in which the engagement devices 34 have a second length greater than the first length. Optionally, linearly movable engagement devices 34 may be biased into the extended configuration to facilitate engagement between the engagement features 34 and the skimmer 24. In such embodiments, one or more biasing members may apply a biasing force on the engagement features 34 for applying a force or pressure to the engagement features 34 and controlling movement and/or maintaining a specific positioning of the engagement features 34 relative to the dock 32 in the absence of an external force. Non-limiting examples of the biasing member may include, but are not limited to, various springs, compression members, elastic materials, combinations thereof, and/or other suitable biasing members

Optionally, and as illustrated in FIG. 1, cabling 36 of the docking station 14 may extend through the skimmer 24 to minimize and/or reduce exposure of the cabling 36 within the pool 12 and/or on coping of the pool 12. In such embodiments, the optional cabling 36 may extend through the top opening 42. However, in other embodiments, the cabling 36 may extend through other portions of the skimmer 24 as desired. Moreover, in other embodiments, the docking station 14 need not include the cabling 36.

Referring to FIG. 3, the docking station 14 additionally, or alternatively, may be attachable to the circulation port 26. The circulation port 26 may be an opening for a circulation system of the pool 12 (e.g., including a pump for drawing water through the circulation system). As non-limiting examples, the port 26 may be a suction inlet and/or outlet. In certain embodiments, and as illustrated in FIG. 3, the circulation port 26 optionally includes a port fitting 50 and/or other hardware such as but not limited to housings, plastic, fasteners, etc.

In embodiments where the docking station 14 is attachable to the circulation port 26, the docking station 14 may include one or more support openings 52, which may receive the port fitting 50 and/or other hardware at the circulation port 26 therethrough. A locking device 54 may secure the docking station 14 on the port fitting 50 and/or other hardware of the port 26 using various techniques or mechanisms as desired. In one non-limiting example, the locking device 54 may engage the port fitting 50 and/or other hardware extending through the support opening 52, thereby clamping or securing the dock 32 on the port fitting 50 and/or other hardware. Optionally, the dock 32 may include a recess 56 for at least partially receiving the locking device 54; however, in other embodiments, the recess 56 need not be included.

In embodiments where the docking station 14 is attached to the port 26, the optional cabling 36 may extend through the port 26, along coping of the pool 12, and/or as otherwise desired.

Referring to FIGS. 4 and 5, the docking station 14 additionally, or alternatively, may be attached to the pool light fitting 28. The pool light fitting 28 generally includes a sheath or housing 58 provided in an opening in a surface of the pool 12. Optionally, the pool 12 includes an interior 60 configured to at least partially receive the pool light 30. The pool light fitting 28 may accommodate various types of pool lights 30 as desired, such as but not limited to light emitting diode (LED) pool lights 30.

In certain embodiments, the docking station 14 includes one or more fitting engagement features 62 configured to engage the pool light fitting 28, such as but not limited to the housing 58. In some embodiments, the fitting engagement features 62 may be openings similar to the support openings 52, and a sealing cap and/or other locking device may engage the portion of the pool light fitting 28 in the opening, optionally sealing the pool light fitting 28. Additionally, or alternatively, the fitting engagement features 62 may include friction members, a ridge, hooks, clips, clasps, a cavity, combinations thereof, and/or as otherwise desired, optionally sealing the pool light fitting 28. In FIG. 5, the fitting engagement feature 62 is a shoulder region 65 configured to engage the housing 58.

In various embodiments, the docking station 14 may be attachable to the pool light fitting 28 without removing the pool light 30. In such embodiments, the docking station 14 may or may not obstruct light emitted from the pool light 30, and optionally the docking station 14 allows for light from the pool light 30 to be emitted through the dock 32 (e.g., when the fitting engagement feature 62 is an opening). In other embodiments, the docking station 14 may be attachable to the pool light fitting 28 after removal of the pool light 30 from the pool light fitting 28. In such embodiments, and/or embodiments where the docking station 14 obstructs the pool light 30, the docking station 14 optionally includes an onboard light source 64, which may be synced and/or otherwise controlled to function as the pool light 30 which is replaced and/or obstructed.

Optionally, and as illustrated in FIG. 5, cabling 36 of the docking station 14 may extend through the pool light fitting 28 to minimize and/or reduce exposure of the cabling 36 within the pool 12 and/or on coping of the pool 12.

Optionally, and as illustrated in FIG. 5, the docking station 14 supported on the wall 18 of the pool 12 may include one or more positioning features 66 on the dock 32, which may be utilized to control an orientation of the dock 32. As a non-limiting example, the positioning feature 66 may be utilized to position the dock 32 in a vertical orientation rather than at an angled orientation along the wall 18.

The aforementioned examples are for illustrative purposes and should not be considered limiting, and in other embodiments, the docking stations 14 described herein may be attachable to and/or supported on other existing features 13 of the pool 12 as desired.

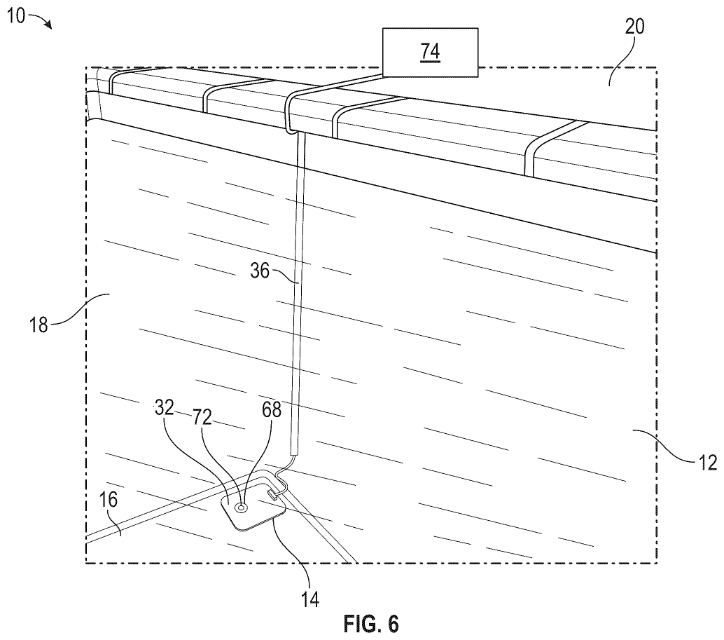

In other embodiments, and as illustrated in FIG. 6, the docking station 14 need not be supported on a feature 13, and instead may be provided on the floor 16 of the pool 12. In such embodiments, the docking station 14 may be provided at various locations on the floor 16 as desired. Optionally, the dock 32 may be positioned proximate to the wall 18 to minimize exposure of cabling 36 within the pool 12.

Regardless of where the docking station 14 is installed within the pool 12, in certain embodiments, the docking station 14 optionally includes associated human-machine interface (HMI) 35 with one or more features for providing information to a user and/or for receiving input from a user. The HMI 35 includes various features for receiving input from and/or providing output to a user, such as but not limited to a display, a speaker, a button, a switch, a dial, a keypad, a light source, combinations thereof, and/or as otherwise desired. The information provided to the user via the HMI 35 may be various information as desired, such as but not limited to a charging status of the pool cleaner 11, a filter status of the pool cleaner 11, a cleaning or operational status of the pool cleaner 11, a power level of the docking station, a power source for the docking station, a communication status, system information about the pool itself or the pool cleaner 11 (e.g., obtained from the pool cleaner 11, sensors, user, etc.), and/or various other information as desired. In some embodiments, and as illustrated in FIG. 1, for example, the HMI 35 may be remote from the dock 32. In such embodiments, the HMI 35 may be connected to the dock 32 via wired communication (e.g., via electrical cabling 36) and/or wireless communication. Additionally, or alternatively, the HMI 35 (or another HMI) may be provided on the dock 32 itself.

In various embodiments, the docking station 14 includes one or more communication modules allowing for wireless communication (e.g., Bluetooth, Wi-Fi, etc.) with external or remote devices such as external control devices, the internet, cloud services, smartphones, other user devices, etc. The communication modules may be provided at various locations on the docking station 14 as desired. The docking station 14 with wireless communication may function as an above-water communication station to relay cleaner information (and/or other information, such as information about a water characteristic of the pool) to and from remote devices. In certain embodiments, the docking station 14 with wireless communication may facilitate communication to and from an underwater pool cleaner 11 at least while the pool cleaner 11 is docked with the docking station 14. Moreover, in some embodiments, the docking station 14 with wireless communication may allow for the HMI 35 to be provided on a user device (e.g., running on an application).

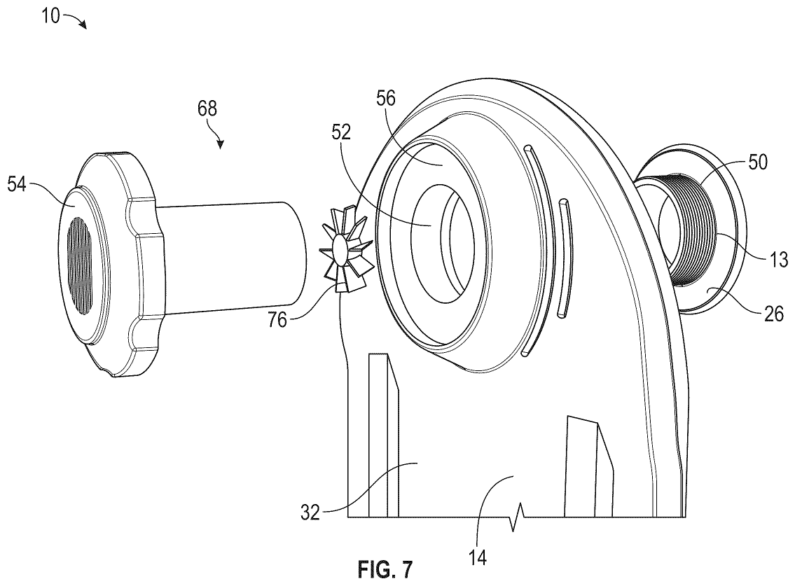

As mentioned, in certain embodiments, the docking stations 14 described herein optionally may be connected to external power sources and/or communication devices via cabling 36. In certain embodiments, and as illustrated in FIGS. 6 and 7, the docking stations 14 described herein optionally include one or more onboard power sources 68.

In some embodiments, the onboard power sources 68 may include a store of energy (e.g., one or more batteries). In one non-limiting example, a docking station 14 may include one or more batteries 70 onboard the dock 32 of the docking station 14, which may be used to charge the pool cleaner 11 while the pool cleaner 11 is docked.

Additionally, or alternatively, the onboard power sources 68 may include an energy-generating system or device capable of generating energy for charging the pool cleaner 11 and/or a battery 70.

In one non-limiting example, and as illustrated in FIG. 6, the energy-generating onboard power source 68 may include a solar panel 72. The solar panel 72 may be provided on the dock 32 of the docking station 14 in some embodiments, although in other embodiments the solar panel 72 may be provided on other components of the docking station 14. As a non-limiting example, the docking station 14 optionally includes a base 74 positionable on the pool deck 20, and the base 74 may include the solar panel 72. Optionally, the solar panel 72 includes a tracker and/or a control system so the solar panel 72 may track a position of the sun relative to the solar panel 72, and the solar panel 72 may automatically adjust its orientation to face the sun to maximize performance of the solar panel 72. Other controls of the solar panel 72 may be implemented as desired.

In another non-limiting example, and as illustrated in FIG. 7, the energy-generating onboard power source 68 may generate energy based on a flow of water for charging a pool cleaner 11 and/or a battery 70. As a non-limiting example, the docking station 14 attachable to the port 26 may include an onboard power source 68 which generates energy based on the flow of water through or from the port 26. In some embodiments, the onboard power source 68 includes an impeller 76 supported on or by the dock 32, and as water flows through the port 26 (e.g., via a pump of the circulation system), the flow of water may cause the impeller 76 to rotate, thereby generating energy.

Various other benefits and advantages may be realized with the systems, devices, and methods provided herein, and the aforementioned advantages should not be considered limiting.

Exemplary concepts or combinations of features of the invention may include:
A. A docking station for a pool cleaner comprising a dock attachable to at least one of a skimmer of a pool or spa, a port of a circulation system of the pool or spa, or a pool light fitting of the pool or spa.
B. The docking station of any preceding or subsequent statement or combinations of statements, wherein the dock is attachable to the skimmer.
C. The docking station of any preceding or subsequent statement or combinations of statements, further comprising electrical cabling for the dock, wherein the electrical cabling is configured to extend through the skimmer.
D. The docking station of any preceding or subsequent statement or combinations of statements, wherein the dock comprises one or more engagement devices configured to engage the skimmer and attach the dock to the skimmer.
E. The docking station of any preceding or subsequent statement or combinations of statements, wherein the one or more engagement devices are adjustable between a base configuration and an extended configuration.
F. The docking station of any preceding or subsequent statement or combinations of statements, wherein the one or more engagement devices are movable or adjustable relative to the dock.
G. The docking station of any preceding or subsequent statement or combinations of statements, wherein the one or more engagement devices comprise at least one friction member.
H. The docking station of any preceding or subsequent statement or combinations of statements, wherein the dock is attachable to the skimmer such that the dock extends along a wall or generally vertical surface of the pool or spa.
I. The docking station of any preceding or subsequent statement or combinations of statements, wherein the dock is attachable to the port.
J. The docking station of any preceding or subsequent statement or combinations of statements, wherein the port is a suction inlet or outlet.
K. The docking station of any preceding or subsequent statement or combinations of statements, wherein the dock is attachable to a fitting of the port.
L. The docking station of any preceding or subsequent statement or combinations of statements, wherein the dock comprises an opening configured to receive the port or fitting through the dock.
M. The docking station of any preceding or subsequent statement or combinations of statements, further comprising a locking feature configured to secure the dock on the port or fitting.
N. The docking station of any preceding or subsequent statement or combinations of statements, wherein the locking feature is configured to clamp the dock on the inlet or fitting.
O. The docking station of any preceding or subsequent statement or combinations of statements, wherein the dock further comprises a recess on an outward-facing surface of the dock configured to at least partially receive the locking device.
P. The docking station of any preceding or subsequent statement or combinations of statements, further comprising an onboard system configured to generate power via water flow through the port.
Q. The docking station of any preceding or subsequent statement or combinations of statements, wherein the onboard system comprises an impeller supported on the dock.
R. The docking station of any preceding or subsequent statement or combinations of statements, wherein the power-generating system is configured to charge at least one of an onboard battery or a pool cleaner docked with the docking station.
S. The docking station of any preceding or subsequent statement or combinations of statements, wherein the dock is attachable to the pool light fitting.
T. The docking station of any preceding or subsequent statement or combinations of statements, wherein the dock is attachable to a sheath or housing of the pool light fitting positionable within an opening in the pool or spa.
U. The docking station of any preceding or subsequent statement or combinations of statements, wherein the dock is attachable to an LED light component.
V. The docking station of any preceding or subsequent statement or combinations of statements, further comprising electrical cabling for the dock, wherein the electrical cabling is configured to extend through the pool light fitting.
W. The docking station of any preceding or subsequent statement or combinations of statements, wherein the pool light fitting is a submerged or submergible pool light component.
X. The docking station of any preceding or subsequent statement or combinations of statements, wherein the dock further comprises at least one of a solar panel or an onboard power source.
Y. The docking station of any preceding or subsequent statement or combinations of statements, wherein the solar panel includes a tracker and/or a control system so the solar panel may track a position of the sun relative to the solar panel, and wherein the solar panel may automatically adjust its orientation to face the sun to maximize performance of the solar panel.
Z. The docking station of any preceding or subsequent statements or combination of statements, further comprising a base connected to the dock.
AA. The docking station of any preceding or subsequent statements or combination of statements, wherein the base comprises at least one of a solar panel or an onboard power source.
BB. The docking station of any preceding or subsequent statement or combination of statements, further comprising at least one positioning feature on the dock configured to control an orientation of the dock.
CC. The docking station of any preceding or subsequent statement or combination of statements, wherein the docking station comprises a light source.
DD. The docking station of any preceding or subsequent statement or combination of statements, wherein the light source is synced with other pool lights of the pool or spa.
EE. The docking station of any preceding or subsequent statement or combination of statements, further comprising an onboard human machine interface.
FF. The docking station of any preceding or subsequent statement or combination of statements, further comprising a human machine interface for the docking station remote from the dock.
GG. A docking station comprising a dock that is positionable on a floor or generally horizontal submerged surface of a pool or spa, wherein the dock comprises a solar panel.
HH. The docking station of any preceding or subsequent statement or combinations of statements, wherein the dock further comprises an onboard battery.
II. The docking station of any preceding or subsequent statement or combinations of statements, further comprising electrical cabling extending from the dock to a location outside of the pool or spa.
JJ. An underwater docking station for a pool cleaner configured to generate electrical energy based on a flow of water.
KK. The docking station of any preceding or subsequent statement or combinations of statements, wherein the docking station comprises an impeller configured to generate the electrical energy based on the flow of water.
LL. The docking station of any preceding or subsequent statement or combinations of statements, wherein the docking station is attachable to a suction inlet or outlet of a pool or spa, and wherein the flow of water is to or from the suction inlet or outlet.

These examples are not intended to be mutually exclusive, exhaustive, or restrictive in any way, and the invention is not limited to these example embodiments but rather encompasses all possible modifications and variations within the scope of any claims ultimately drafted and issued in connection with the invention (and their equivalents). For avoidance of doubt, any combination of features not physically impossible or expressly identified as non-combinable herein may be within the scope of the invention. Further, although applicant has described devices and techniques for use principally with pool cleaners, persons skilled in the relevant field will recognize that the present invention conceivably could be employed in connection with other objects and in other manners. Finally, references to “pools” and “swimming pools” herein may also refer to spas or other water containing vessels used for recreation, training, or therapy and for which cleaning of debris is needed or desired.

That which is claimed:

1. A docking station for a pool cleaner comprising a dock attachable to at least one of a skimmer of a pool or spa, a port of a circulation system of the pool or spa, or a pool light fitting of the pool or spa.

2. The docking station of claim 1, wherein the dock is attachable to the skimmer.

3. The docking station of claim 1, wherein the dock further comprises one or more engagement devices configured to engage the skimmer and attach the dock to the skimmer.

4. The docking station of claim 3, wherein the one or more engagement devices are adjustable between a base configuration and an extended configuration.

5. The docking station of claim 3, wherein the one or more engagement devices are movable or adjustable relative to the dock.

6. The docking station of claim 3, wherein the one or more engagement devices comprise at least one friction member.

7. The docking station of claim 1, wherein the dock is attachable to the port or a fitting of the port.

8. The docking station of claim 7, wherein the dock comprises an opening configured to receive the port or the fitting of the port through the dock.

9. The docking station of claim 7, further comprising a locking feature configured to secure the dock on the port or fitting.

10. The docking station of claim 7, further comprising an onboard system configured to generate power via water flow through the port.

11. The docking station of claim 1, wherein the dock is attachable to the pool light fitting.

12. The docking station of claim 1, wherein the dock further comprises a solar panel, wherein the solar panel includes a tracker and/or a control system so the solar panel may track a position of the sun relative to the solar panel, and wherein the solar panel may automatically adjust its orientation to face the sun to maximize performance of the solar panel.

13. The docking station of claim 1, wherein the docking station comprises a light source.

14. The docking station of claim 1, further comprising an onboard human machine interface.

15. A docking station comprising a dock that is positionable on a floor or generally horizontal submerged surface of a pool or spa, wherein the dock comprises a solar panel.

16. The docking station of claim 15, wherein the dock further comprises an onboard battery.

17. The docking station of claim 15, further comprising electrical cabling extending from the dock to a location outside of the pool or spa.

18. An underwater docking station for a pool cleaner configured to generate electrical energy based on a flow of water.

19. The docking station of claim 18, wherein the docking station comprises an impeller configured to generate the electrical energy based on the flow of water.

20. The docking station of claim 18, wherein the docking station is attachable to a suction inlet or outlet of a pool or spa, and wherein the flow of water is to or from the suction inlet or outlet.
